(19) United States
(12) Patent Application Publication
(10) Pub. No.: US 2024/0381128 A1
(43) Pub. Date: Nov. 14, 2024

(54) CONFIGURATION OF A REPEATER STATION IN A WIRELESS COMMNUICATION NETWORK

(71) Applicant: Sony Group Corporation, Tokyo (JP)

(72) Inventor: Rickard LJUNG, Helsingborg (SE)

(21) Appl. No.: 18/696,664

(22) PCT Filed: Sep. 23, 2022
(86) PCT No.: PCT/EP2022/076505

§ 371 Date: Mar. 28, 2024

(30) Foreign Application Priority Data
Oct. 26, 2021 (SE) 2151310-6

(51) Int. Cl. H04W 24/02; H04L 5/00; H04W 8/22; H04W 24/10

(52) U.S. Cl. CPC H04W 24/02; H04L 5/0051; H04W 8/22; H04W 24/10

(57) ABSTRACT

Method carried out in a first radio node (121) of a wireless network (100) for configuring a repeater station (20) to repeat radio signals between the wireless network and at least one wireless device. the method comprising: configuring (402) the repeater station to detect one or more further radio nodes of the wireless network: receiving (404) an indication of measurement data. obtained in the repeater station based on a reference signal from a second radio node (122) of said one or more further radio nodes: transmitting (406) a control signal to control the repeater to repeat radio signals associated with at least one of the first radio node and the second radio node, based on the received indication.

### TECHNICAL FIELD

This disclosure is related to wireless communication between a wireless device and a radio node of a wireless system, such as an access node of a wireless network. Specifically, solutions are provided for configuring operation of a repeater station to convey communication signals between the radio node and the wireless device.

### BACKGROUND

Various protocols and technical requirements for wireless communication have been standardized under supervision of inter alia the 3rd Generation Partnership Project (3GPP). Improvement and further development are continuously carried out, and new or amended functions and features are thus implemented in successive releases of the technical specifications providing the framework for wireless communication.

Wireless communication may in various scenarios be carried out between a wireless network and a wireless device. The wireless network typically comprises an access network including a plurality of access nodes, which historically have been referred to as base stations. In a 5G radio access network such a base station may be referred to as a gNB. Each access node may be configured to serve one or more cells of a cellular wireless network. A variety of different types of wireless devices may be configured to communicate with the access network, and such wireless devices are generally referred to as User Equipment (UE). Communication which involves transmission from the UE and reception in the wireless network is generally referred to as Uplink (UL) communication, whereas communication which involves transmission from the wireless network and reception in the UE is generally referred to as Downlink (DL) communication. In various scenarios, the UE may be configured to communicate directly with another wireless device. This may for certain applications be referred to as sidelink communication in 3GPP specifications.

In order to increase or improve coverage of a wireless network, a repeater station may be employed. This may e.g. be the case near a cell edge, or where an environment causes problems of maintaining a sufficiently strong or reliable access link between the wireless network and wireless devices. The repeater station, or repeater for short, is a device configured to forward radio signals. In some realizations, the repeater station may be a passive device, configured to reflect or possibly redirect, a signal as detected. Alternatively, the repeater station may be configured to amplify and transmit a received radio signal. In either case, the repeater station is configured to receive a signal in a configured frequency range and transmit a signal in the same frequency range. Such a traditional repeater station, also referred to as an RF (radio frequency) repeater, is typically configured for omnidirectional or fixed directional Tx/Rx (transmission/reception), and with no distinction between UL/DL.

In 3GPP discussions towards potential Release 18 topics, a so-called smart repeater concept has been proposed, where the repeater function has a higher complexity in its structure by being combined with a control signal possibility towards the host base station (gNB). With the control signal possibility, the gNB should be able to inform the relay about expected on/off periods over time to select suitable time slots to amplify, provide the relay with a used TDD (Time Division Duplex) UL/DL slot allocations, and also support the relay with its beam management. The disclosure RWS210019, of 3GPP TSG RAN Rel 18 workshop Electronic Meeting, Jun. 28-Jul. 2, 2021, outlines various aspects of such a proposal.

However, there is still room for improvements in the art of repeater stations, such as with respect to control and adaptation of the repeater to obtain enhanced or improved use of the repeater function. In particular, there is room for improvement for handling communication over a repeater based on changes that affect the repeater's ability or quality in carrying out repeater operation.

### SUMMARY

In view of the foregoing, solutions are presented herein for a repeater station configured for repeating signals between a wireless network and at least one wireless device, and for a radio node of a wireless network for configuring the repeater station. The invention is defined by the independent claims.

According to one aspect, a method carried out in a first radio node of a wireless network is provided, for configuring a repeater station to repeat radio signals between the wireless network and at least one wireless device, the method comprising:
configuring the repeater station to detect one or more further radio nodes of the wireless network;
receiving an indication of measurement data, obtained in the repeater station based on a reference signal from a second radio node of said one or more further radio nodes;
transmitting a control signal to control the repeater to repeat radio signals associated with at least one of the first radio node and the second radio node, based on the received indication.

According to a second aspect a method carried out in a repeater station is provided, for enabling the repeater to repeat signals between a wireless network and at least one wireless device, the method comprising:
obtaining, from a first radio node of the wireless network, configuration information for the repeater station to detect one or more further radio nodes of the wireless network;
measuring a signal characteristic of a reference signal, received from a second radio node of said one or more further radio nodes, to generate measurement data;
transmitting an indication of the measurement data to the first radio node;
receiving a control signal from the first radio node, which controls the repeater station to repeat radio signals associated with at least one of the first radio node and the second radio node, based on the transmitted indication.

The proposed solution provides the technical effect of improved flexibility in the operation of a repeater station, which allows for the repeater station to be configured to be operative for repetition of radio signals associated with different radio nodes, or cells, e.g. in case mobility or radio link obscurement causes a change of access link characteristics.

Various further advantageous features are set out in the dependent claims and are discussed and explained in further detail in the following detailed description.

### BRIEF DESCRIPTION OF THE DRAWINGS

FIG. 1 schematically illustrates an implementation of a wireless communication system, in which a UE communicates with a radio node, such as an access node of a wireless network, over a repeater station.

FIG. 2 schematically illustrates a repeater station configured to operate with the wireless network according to various examples.

FIG. 3 schematically illustrates an access node of the wireless network according to various examples.

FIG. 4 illustrates different steps which may be included in various examples of the proposed solution in a method carried out in a radio node.

FIG. 5 illustrates different steps which may be included in various examples of the proposed solution in a method carried out in a repeater station.

FIG. 6 illustrates an example of a context of the proposed solution and signaling between associated entities of the system.

FIG. 7 schematically shows timing information associated with a switching scheme for operating a repeater station according to one example of the proposed solution.

FIG. 8 schematically shows timing information associated with a switching scheme for operating a repeater station having dual radio capability, according to one example of the proposed solution.

FIG. 9 schematically shows timing information associated with a switching scheme for operating a repeater station having dual radio capability, with configured duplex operation, according to one example of the proposed solution.

FIG. 10 shows a high level signaling diagram of various examples of the proposed solution.

### DETAILED DESCRIPTION

In the following description, for purposes of explanation and not limitation, details are set forth herein related to various examples. However, it will be apparent to those skilled in the art that the present invention may be practiced in other examples that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) (ASIC), and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof. The terms “receive” or “receiving” data or information shall be understood as “detecting, from a received signal”.

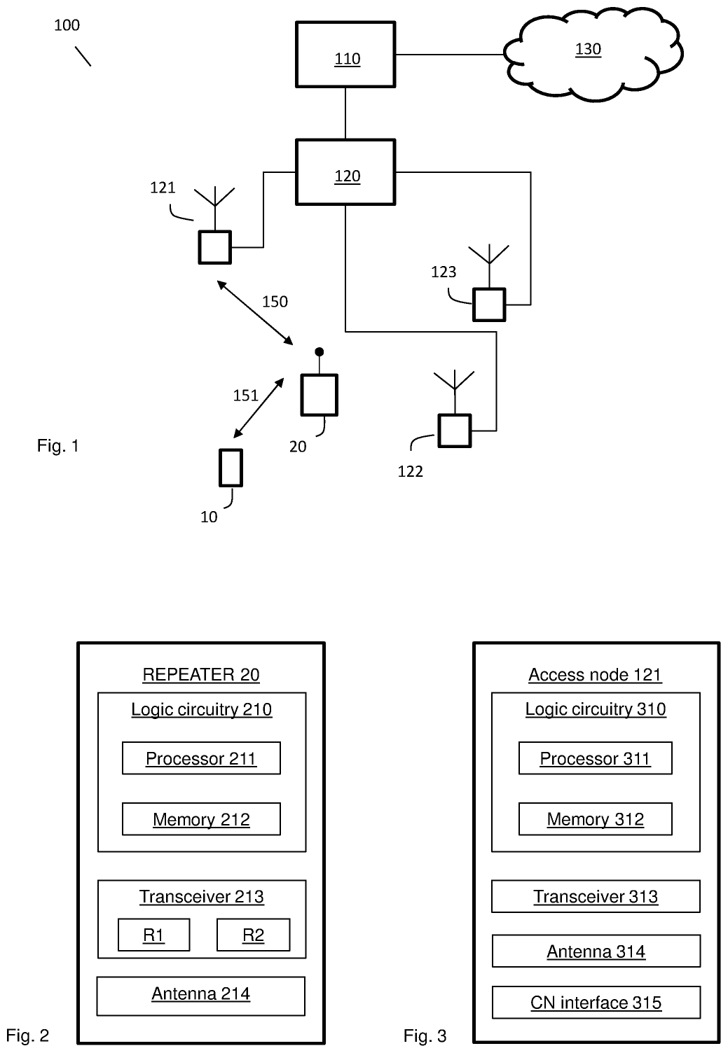

FIG. 1 illustrates a high-level perspective of operation in a wireless system, wherein a UE 10 is configured to communicate with a wireless network 100. The wireless network 100 may be a radio communication network 100, configured to operate under the provisions of technical specifications specified by 3GPP, such as for 5G NR or any future releases, according to various examples outlined herein. The wireless network 100 may comprise a core network 110, which in turn may comprise a plurality of core network nodes. The core network is connected to at least one access network 120 comprising one or more base stations or access nodes, of which access nodes 121-123 are illustrated. The access node 121 is a radio node configured for wireless communication on a physical channel with various UEs, of which the UE 10 is shown. The core network 110 may in turn be connected to other networks 130. A repeater station 20 is configured to operate in the wireless network 100, to repeat signals between the wireless network and at least one wireless device, such as the UE 10. The repeater station 20 may in this context be configured by the wireless network 100, such as by a hosting base access node 121, to operate in accordance with a certain UL/DL TDD scheme, and within a certain frequency range.

Before discussing further details and aspects of the proposed method, functional elements for the repeater station 20, or the repeater 20 for short, configured to carry out the proposed solution, will be briefly discussed.

FIG. 2 schematically illustrates an example of the repeater 20 for use in a wireless network 100 as presented herein, and for carrying out various method steps as outlined.

The repeater 20 comprises a transceiver 213 for communicating with other entities of the radio communication network 100, such as with the access node 121 and the UE 10, in different frequency bands. The transceiver 213 may thus include at least a first radio unit R1, and optionally at least a second radio unit R2, for communicating through an air interface. Each radio R1, R2 may, in turn, comprise an amplifier unit, configured to amplify a received signal before transmitting the amplified signal. For operation as a repeater station towards one or more UEs, each radio unit R1, R2 acts as an analog pass-through, and is controlled to receive and transmit (and possibly amplify) a signal without decoding or data manipulation.

The repeater 20 may further comprise an antenna system 214, which may include one or more antennas, antenna ports or antenna arrays. In various examples the repeater 20 is configured to operate with a single beam, wherein the antenna system 214 is configured to provide an isotropic sensitivity to transmit radio signals. In other examples, the antenna system 214 may comprise a plurality of antennas for operation of different beams in transmission and/or reception. The antenna system 214 may comprise different antenna ports, to which the Rx 2131 and the Tx 2132, respectively, may selectively be connected. For this purpose, the antenna system 214 may comprise an antenna switch.

The repeater 20 further comprises logic circuitry 210 configured to communicate, via the radio transceiver, with a hosting node of the wireless network 100, such as the access node 121. The logic circuitry 210 may be configured to encode and decode control signaling within communication with the wireless network 100. The logic circuitry 210 may also be configured to control the transceiver 213 and possibly the antenna system 214 to transmit and receive dedicated and/or broadcasted signals for such control signaling between the wireless network 100 and the repeater station 20. This may involve receiving control signals for operation of the transceiver 213 and transmitting information to the access node 121. Received control signals may comprise control information associated with TDD configuration for UL/DL switching, beamforming configuration for controlling the antenna system 214, on/off information for controlling operation activity of the repeater 20, frequency band configuration, etc. The logic circuitry 210 is further configured to control the transceiver 213, and possibly the antenna system 214, to operate according to received control signals, or in accordance with one or more predetermined rules or switching schemes.

The logic circuitry 210 may include a processing device 211, including one or multiple processors, microprocessors, data processors, co-processors, and/or some other type of component that interprets and/or executes instructions and/or data. The processing device 211 may be implemented as hardware (e.g., a microprocessor, etc.) or a combination of hardware and software (e.g., a system-on-chip (SoC), an application-specific integrated circuit (ASIC), etc.). The processing device 211 may be configured to perform one or multiple operations based on an operating system and/or various applications or programs.

The logic circuitry 210 may further include memory storage 212, which may include one or multiple memories and/or one or multiple other types of storage mediums. For example, the memory storage 212 may include a random access memory (RAM), a dynamic random access memory (DRAM), a cache, a read only memory (ROM), a programmable read only memory (PROM), flash memory, and/or some other type of memory. The memory storage 212 may include a hard disk (e.g., a magnetic disk, an optical disk, a magneto-optic disk, a solid state disk, etc.). The memory storage 212 is configured for holding computer program code, which may be executed by the processing device 211, wherein the logic circuitry 210 is configured to control the UE 10 to carry out any of the method steps as provided herein. Software defined by said computer program code may include an application or a program that provides a function and/or a process. The software may include device firmware, an operating system (OS), or a variety of applications that may execute in the logic circuitry 210.

Obviously, the repeater 20 may include other features and elements than those shown in the drawing or described herein, such as a power supply, a casing, sensors, etc., but these are left out for the sake of simplicity. Further features and functions of the repeater 20 will be discussed below.

FIG. 3 schematically illustrates a radio node in the form of an access node 121 of the wireless network 100 as presented herein, and for carrying out the method steps as outlined. In various examples, the access node 121 is a radio base station for operation in the radio communication network 100, to serve one or more radio UEs, such as the UE 10.

The access node 121 may comprise a wireless transceiver 313, such as a radio transceiver for communicating with other entities of the radio communication network 100, such as the terminal 10. The transceiver 313 may thus include a radio receiver and transmitter for communicating through at least an air interface.

The access node 121 further comprises logic circuitry 310 configured to control the access node 121 to communicate with the UE 10 via the radio transceiver 313 on a physical channel.

The logic circuitry 310 is further configured to control the repeater 20, wherein the access node 121 acts as a host for the repeater 20. This may include transmitting, on a control channel by means of the transceiver 313, control signals to the repeater 20 to configure the repeater to repeat signals according to a certain configuration. Control signals may provide repeater configuration information associated with inter alia TDD configuration for UL/DL switching, beamforming configuration, direction of signal reflection, on/off information for controlling operation activity of the repeater 20, frequency band configuration, etc.

The logic circuitry 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic circuitry 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magneto-optic disk, a solid state disk, etc.).

The memory storage 312 is configured for holding computer program code, which may be executed by the processing device 311, wherein the logic 310 is configured to control the access node 121 to carry out any of the method steps as provided herein. Software defined by said computer program code may include an application or a program that provides a function and/or a process. The software may include device firmware, an operating system (OS), or a variety of applications that may execute in the logic 310.

The access node 121 may further comprise, or be connected to, an antenna 314, which may include an antenna array. The logic 310 may further be configured to control the radio transceiver to employ an anisotropic sensitivity profile of the antenna array to transmit radio signals in a particular transmit direction. The access node 121 may further comprise an interface 315, configured for communication with the core network 110. Obviously, the access node 121 may include other features and elements than those shown in the drawing or described herein, such as a power supply and a casing etc.

Solutions are provided herein, targeting various scenarios that may affect successful or adequate repeater operability. According to one aspect, the repeater 20 may be mobile, e.g. mounted on a vehicle such as train, bus, drone, or car. When considering a smart repeater to be moving, there are additional issues that may occur, e.g. how to handle that the relay can be moving in and out of coverage from different cells within the wireless network 100, and also that the relay may over time be situated in good but also bad locations within the cell with respect to the interference caused by a detect-and-amplify function of the repeater 20. According to another aspect, the radio environment between the repeater 20 and its host radio node 121, or between the repeater 20 and a served UE 10, may change. This may e.g. be caused by mobility of one or more of the radio node 121, the repeater 20, and the UE 10, or by changes in the environment, such as objects passing or blocking one or more radio paths. Based on inter alia such scenarios, control signaling enhancements and extended operation of the repeater 20 is proposed.

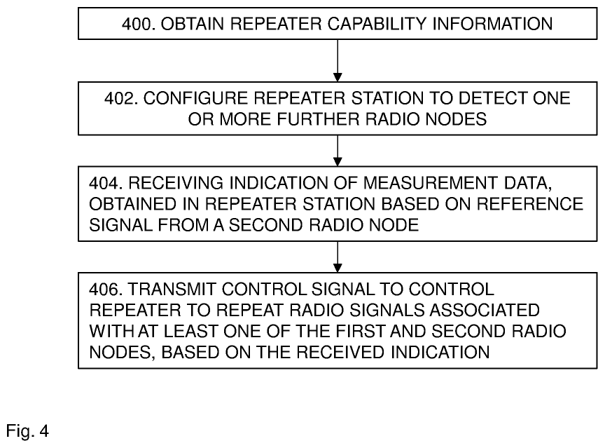

FIG. 4 shows a flow chart of various steps carried out by a radio node 121, here referred to as a first radio node 121, of a wireless network 100, for configuring a repeater 20 to repeat radio signals between the wireless network 100 and at least one wireless device, or UE, 10. The first radio node 121 may in this context act as a host for the repeater 20. The steps below may be carried out by the logic circuitry 310, wherein the processing device 311 is configured to execute computer program code held in the memory storage 312, to control the radio node 121 to carry out the described method steps. The method comprises:

In step 402, the first radio node 121 configures the repeater 20 to detect one or more further radio nodes 121-123 of the wireless network 100. This may involve transmitting configuration information to the repeater 20, identifying how to detect such further radio nodes.

In step 404, the first radio node 121 receives 404 an indication of measurement data, obtained in the repeater 20 based on a reference signal from at least a second radio node 121 of said one or more further radio nodes.

In step 406, the first radio node 121 transmits a control signal to the repeater 20, to control the repeater 20 to repeat radio signals associated with at least one of the first radio node and the second radio node, based on the received indication.

The proposed solution thus involves the first radio node 121 sharing information related to further radio nodes 121, 123 with the repeater 20, and based on the repeater informing the first radio node 121 on measurements made on such further radio nodes 121, 123, the first radio may configure the repeater 20 to repeat radio signals associated with at least one of the first radio node and the second radio node. In this context, radio signals being associated with one radio node means DL and/or UL signaling between that one radio node and a further node, such as the UE 10. Communication for control signaling between the first radio node 121 and the repeater 20 may be carried out on a configured control signal.

In certain examples, the repeater 20 may comprise two radio units R1, R2. This allows for the repeater 20 to repeat signals associated with two different communication paths simultaneously. The method may thus involve a step 400 of obtaining information identifying dual radio capability of the repeater 20. This capability information may be obtained by capability signaling from the repeater 20 to the wireless network, or be obtained from memory storage in the wireless network 100 where such capability information is pre-stored, linked to the repeater 20. The control signal transmitted by the first access node 121 to the repeater 20 in step 406 may identify timing information for the repeater 20 to repeat radio signals associated with either or both of the first radio node 121 and the second radio node 122.

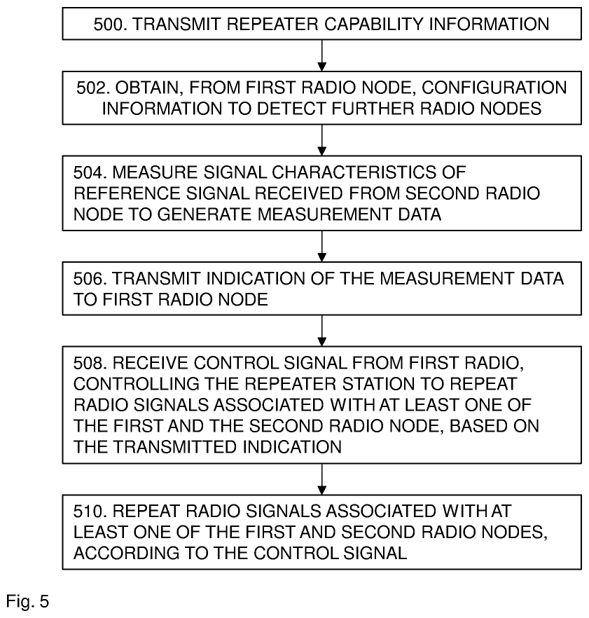

FIG. 5 shows a flow chart of various steps carried out by a repeater 20 for enabling the repeater 20 to repeat signals between a wireless network 100 and at least one UE 10. The repeater 20 may in this context operate under the control of the first repeater 121 acting as host. The steps below may be carried out by the logic circuitry 210, wherein the processing device 211 is configured to execute computer program code held in the memory storage 212, to control the repeater 20 to carry out the described method steps.

In step 502, the repeater 20 obtains, from the first radio node 121, configuration information for the repeater 20 to detect one or more further radio nodes 122, 123 of the wireless network.

In step 504, the repeater 20 measures, based on the configuration information, a signal characteristic of a reference signal received from at least a second radio node 122 of said one or more further radio nodes, to generate measurement data.

In step 506, the repeater 20 transmits an indication of the measurement data to the first radio node.

In step 508, the repeater 20 receives a control signal from the first radio node 121, which controls the repeater station 20 to repeat radio signals associated with at least one of the first radio node and the second radio node, based on the transmitted indication.

The proposed solution thus involves the repeater 20 obtaining information related to further radio nodes 121, 123. The repeater 20 is thus configured to measure signal characteristics of reference signals from such further radio nodes, and to share obtained measurement data with the first, host, radio node 121. Based thereon, the repeater 20 may be configured repeat radio signals associated with at least one of the first radio node and the second radio node.

In certain examples, the repeater 20 may comprise two radio units R1, R2, which allows for the repeater 20 to repeat signals associated with two different communication paths simultaneously. The method may thus involve a step 500 of transmitting information identifying dual radio capability of the repeater 20. This capability information may be shared by capability signaling from the repeater 20 to the wireless network 100. The control signal received from the first access node 121 in step 508 may identify timing information for the repeater 20 to repeat radio signals associated with either or both of the first radio node 121 and the second radio node 122.

Step 510 further identifies the subsequent operation of the repeater 20, wherein the repeater 20 repeats, i.e. receives and transmits, and possibly amplifies, radio signals associated with at least one of the first and second radio nodes, according to the control signal, such as according to a certain switching scheme identified by the control signal.

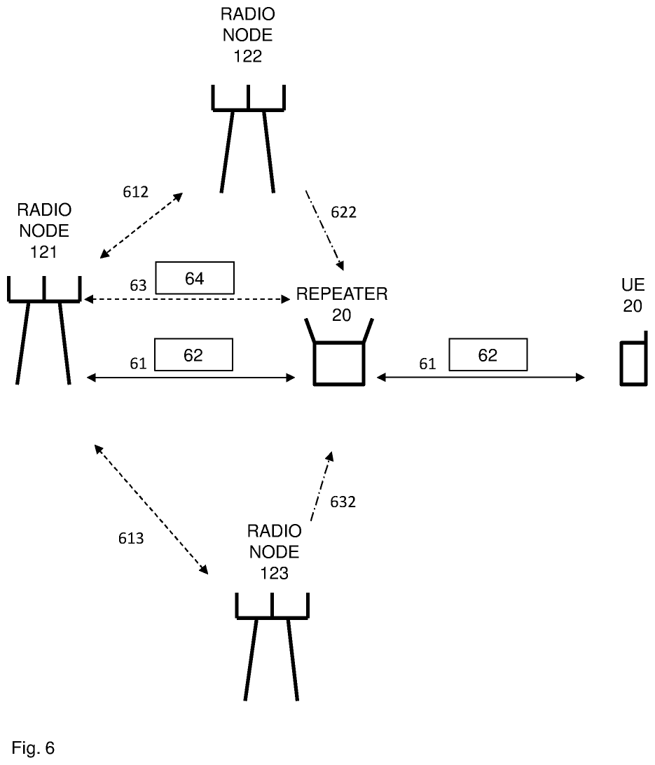

FIG. 6 provides a high level architectural description of the proposed functionality, and shows some of the entities already described with reference to FIGS. 1-3. Herein, the repeater 20 is configured to repeat radio signals 62 on an access link 61 between the wireless network 100 and the UE 10, which may be configured as a repeater-aware UE. In this context, repeating may mean that the repeater 20 forwards the radio signals 62. In some examples, the repeater 20 is further configured to amplify received radio signals 62 before transmitting. Communication of radio signals 62 on the access link 61 may be configured in accordance with an UL/DL TDD scheme. Radio signals 62 on the access link 61 may comprise data channels and control channels.

According to one aspect, the proposed solution involves neighbor information sharing from the first radio node 121 to the repeater 20. This involves configuring the repeater 20 with information about one or more other cells and/or transmission beams, operated by radio nodes 122, 123, within the network 100. This may be obtained by the hosting first radio node 121 transmitting a control signal 64 on a control channel 63. It is here proposed that a control signal 64 from the first radio node 121 configures the repeater 20 to detect one or more further radio nodes 122, 123 of the wireless network 100. This may be obtained by the control signal 64 comprising cell characteristics for such other radio nodes 122, 123. The cell characteristics may comprise information identifying a reference signal for each of said one or more further radio nodes. In some examples, the information may identify beam-specific or cell-specific reference signals for each of said one or more further radio nodes. The cell characteristics may in various examples of this context identify candidate frequency bands, frame timing characteristics (such as sub frame numbering), OFDM (Orthogonal Frequency-Division Multiplexing) numerologies such as subcarrier spacings, sync signal information (location in frequency and time within a frequency band). The information identifying a reference signal may be explicit, e.g. comprising one or more of the mentioned data, or implicit by comprising an indicator which may be linked, in the repeater 20, to the mentioned data in a look-up table held in the memory storage 202.

In some examples, configuring the repeater 20 to detect one or more further radio nodes 122, 123 of the wireless network involves sharing information, such as cell characteristics as described, associated with a neighbor cell list related to the first radio node 121. In some examples, the first radio node 121 obtains measurement data from the UE 10, related to detected cells and or beams, wherein the radio node 121 configures the repeater 20 to detect one or more further radio nodes by sharing information identifying a subset or selection of radio nodes from the neighbor cell list, based on the UE measurement data.

In some examples, the shared information which allows the repeater to detect further radio nodes may point towards radio node transmissions of repeater specific reference signals which are specifically tailored to be meaningful/beneficial to detect by the repeater 20, rather than by one or more UEs. Such repeater specific reference signals may be transmitted by the radio nodes 121-123 with a different spatial configuration (such as wider beams) or using a sync signal configuration which is separate from the sync signals to be detected by UEs within the network 100. The benefit of this would be two-fold. At first, such signaling could be tailored to be used for topology optimizations for repeaters. Since the functionality of repeater 20 and UEs are different in the cells there may be different purposes with the detection probability of the reference signals. As one example, such signaling may be deployed to allow for larger path loss and thereby be easier to be detected by a repeater station compared to signals to be detected by UEs, since a repeater station may be targeted to be located at areas where ordinary UEs have limited coverage or even no coverage. As one example such signaling may be deployed in different transmission beams, such as to cover a certain height within the air, in case the network targets to configure repeater stations to be deployed at high altitudes. Secondly the repeater specific reference signals could be located in frequency and time differently than the reference signals to be detected by UEs for a cell, and this flexibility could be beneficial for enabling e.g. different detection probabilities.

According to various aspects, the first radio node 121, acting as host or donor for the repeater 20, is configured to provide switching signaling to the repeater, for switching at least one of radio node, cell, or beam for application of repetition. This is, as described, obtained by transmitting a control signal 64 to control the repeater 20 to repeat radio signals associated with at least one of the first radio node 121 and a further radio node. In various examples, this may involve providing a switching scheme which entails on/off signaling, configuring the repeater 20 to be operative or non-operative for repetition at various times. This may be arranged by the control signal 64 identifying timing information for the repeater 20 to repeat radio signals. Specifically, in addition to general on/off signaling, node-specific on/off control signaling is provided, which may be based on the indication of measurement data obtained in the repeater from received reference signals from further radio nodes. The principle with this proposal is that since the legacy function includes possibilities to switch off the repeater in certain time periods/slots—these off-periods can be utilized as beneficial for the network 100 in ensuring the repeater 20 being used to enhance mobility by repeating other cells within the proximity of the repeater. On a high level, the indicated off periods for one relaying activity within one cell may be utilized as on-periods for another neighbor cell. In this manner, the network can manage one relay to handle amplifying signals from two (or more) cells, associated with different radio nodes. This increases the flexibility of the wireless network for ensuring proper coverage for UEs.

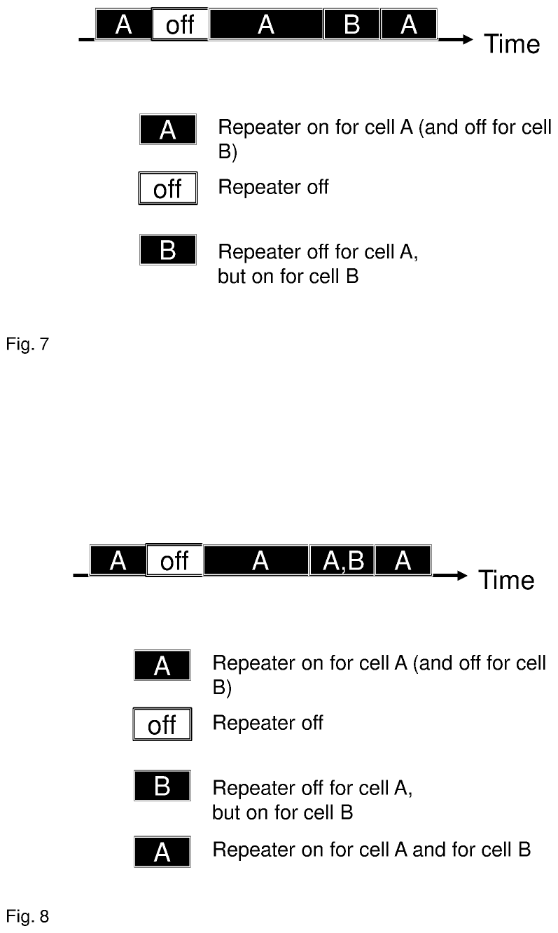

According to the proposed solution, the host or donor access node, or base station, 121 can act as the controlling node also for this scenario. Alternatively, the controlling node is a further node in the access network 120, or in the core network. Nevertheless, communication with the repeater 20 may be executed from the first radio node 121. According to the proposed solution, on/off signaling from the first radio node 121 to the repeater 20 is enhanced, not only with timing information such as a flag indicating on or off per time window, but instead (or in addition) with a cell/beam/radio node indicator per time window. The cell indicates the selection of the radio node on which repeater activity is expected per time window. A schematic example of such timing information, providing how the repeater 20 is configured to switch and operate in time, is provided in FIG. 7. Here, in one example, cell A is provided by radio node 121, whereas cell B is provided by radio node 122. The timing information may thus identify an on-period for the repeater station to repeat radio signals associated with either the first radio node or the second radio node.

As noted above, the repeater 20 may in various examples have multiple radio units R1, R2, to provide at least dual active repeater functionality. Specifically, the repeater 20 may have more than one active radio unit, individually enabling the repeater 20 to detect and amplify signals. According to one aspect, a management control functionality for dual active smart repeaters is provided, which repeaters are capable not only of detecting and amplifying signals from one donor radio node 121, but also a second radio node 122 simultaneously. This allows a more efficient mobility management rather than using a switching delay in-between the different slots/windows of different cell usage. Besides the implementation aspect of two detect-and-amplify chains R1, R2, this involves control signaling information where the repeater 20 indicates its support for the dual radio functionality, as well as dedicated signaling to manage the dual usage. In FIGS. 4 and 5, this is provided as repeater capability information. According to various examples, it is thus proposed that the timing information providing time-based cell/node indication as proposed above is enhanced with a multi-cell/node indication, wherein the radio node 121 can indicate two cells/nodes to be simultaneously repeated. A schematic example of such timing information, providing how the repeater 20 is configured to switch and operate in time, is provided in FIG. 8. Here, in one example, cell A is provided by radio node 121, whereas cell B is provided by radio node 122. The timing information may thus identify an on-period for the repeater station to repeat radio signals associated with either the first radio node or the second radio node, or both the first radio node and the second radio node.

According to a further aspect, the repeater 20 may be specifically configured for UL/DL duplexing. In a dual active repeater functionality as described above, it is thus also proposed that the radio node 121, acting as donor or host, can manage whether the repeater 20 shall perform uplink and/or downlink repeating individually per cell. The repeater could thereby switch between uplink and downlink relaying for the different cells, which may refer to different beams or different radio nodes. Such dual duplexing could cause interference within the repeater 20 that causes high noise levels. It may also cause interference into the system, i.e. to operation of the wireless network 100, where UL/DL slot allocations are important to manage the TDD system functionality. According to one example, the function of the timing information providing specific

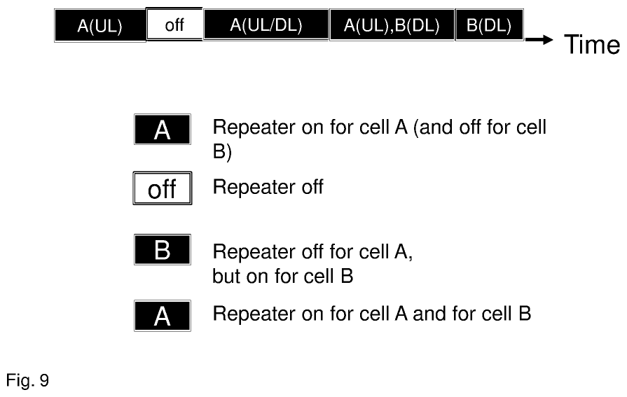

UL/DL configuration to the repeater 20, assistance signaling is provided by the repeater 20, where the repeater 20 transmits capability and condition information to the wireless network 100, e.g. to its host radio node 121, in order to inform which radio conditions need to be met for the dual duplex function to be performed. Such capability and condition information may provide limitations in terms of e.g. output power levels at the repeater 20, detected energy levels from various radio nodes, required frequency gaps in-between the UL and DL parts etc. This information may thus also be provided in either the repeater capability information and/or partly with the indication of measurement data provided to the radio node 121. A schematic example of timing information, which provides how the repeater 20 is configured to switch and operate in time, is provided in FIG. 9. In addition to what was outlined with respect to FIG. 8, this timing information further provides how the repeater shell activates its radio units R1, R2 with respect to UL and DL repetition. The timing information thus further identifies an uplink/downlink scheme for operating the repeater 20.

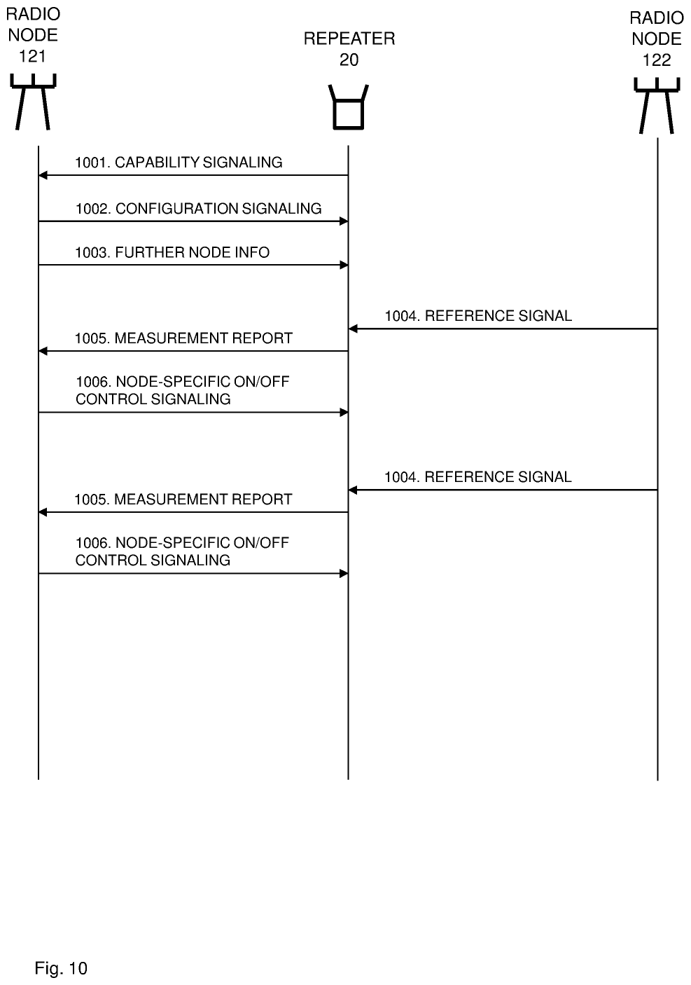

FIG. 10 provides a high level signaling diagram according to various examples of the proposed solution. The diagram does not show actual operation of the repeater 20 in communication between the wireless network 100 and the UE 10, but is rather directed to the configuration of the repeater for enabling repetition with respect to one or more radio nodes, of which the first radio node 121 and the second radio node 122 are shown.

The repeater 20 may provide capability signaling 1001 to the wireless network 100, here identified by the host radio node 121. As outlined, this may involve providing information on dual radio performance and duplexing conditions.

The first radio node 121 may provide configuration signaling to the repeater 20, which as such may involve several messages, to provide e.g. an UL/DL switching scheme for operation with the first radio node 121, frequency settings etc.

It shall be noted that the signaling steps 1001 and 1002 may be connected, wherein capability signaling and configuration signaling are both handled in messages communicated in a common setup procedure. Where steps 1001 and 1002 are separately handled, they may furthermore be carried out in reversed order.

The radio node 121 may further configure the repeater 20 to detect one or more further radio nodes of the wireless network 100, by providing 1003 further node information. This may involve sharing configuration information related to cell characteristics, which e.g. identify a reference signal for each of said one or more further radio nodes, or resource allocation for detecting such reference signals, as described.

The repeater 20 is thereby configured, based on the configuration information, to detect and measure a signal characteristic of a reference signal 1004, received from the second radio node 122, to generate measurement data. The reference signal 1004 may e.g. be a broadcast signal. The measurement data may relate to signal strength or quality of the reference signal 1004.

The repeater 20 transmits a measurement report 1005, comprising an indication of the measurement data, to the first radio node 121. The measurement report may provide explicit measurement data, or an indicator of the measurement data, such as an indication of a signal strength exceeding a certain value.

The first radio node 121 may thereby transmit a control signal providing node-specific on/off control signaling, to control the repeater 20 to repeat radio signals associated with at least one of the first radio node 121 and the second radio node 122, based on the received measurement report. In this context, the radio node 121 may be configured to take repeater capabilities and conditions into account together with self-detected as well as repeater-measured radio conditions into account.

The proposed solution is applicable in TDD systems, meaning there are uplink and downlink time slots with different pattern. Examples of such systems are provided in TS38.213 v15.7-Table 11.1.1-1: Slot formats for normal cyclic prefix. The system may further be configured for operation in multiple bandwidth parts, wherein each bandwidth part can be configured with different OFDM numerology etc. The host radio node 121 can configure the repeater 20 to be active in certain time slots, to forward and possibly amplify the signals in either UL or DL direction. The repeater 20 can further also be configured to be active in a certain frequency.

In some examples, the first radio node 121 may have an inter-node interface with the second radio node 122 within the access network 120. In such a scenario, the first radio node may configure the repeater with a switching scheme, alternating between either radio node 121 or 122, which is determined based on a priority level of communication to be executed from the respective radio node. The priority level may e.g. be based on a quality of service level, a latency requirement, a configured frequency, or other, of the access link in which radio signals are communicated. In another example, the radio node 121 may configure the repeater 20 with timing information configured based on UE-detected signal strength. In such a scenario, measurement reports of signal strength or quality, obtained in the wireless network 100 from UEs, are used for determining the switching scheme. Specifically, measurement reports from UEs which communicate with radio nodes, from which reference signals 1004 are also detected by the repeater 20, can be prioritized dependent on the UE-detected signal strength or quality. The node-specific on/off control signaling 1006 may thus provide timing information associated with a switching scheme which favors UEs reporting weaker connection, i.e. benefitting most of the repeater function. The proposed solution may thus involve obtaining measurement information from one or more UEs communicating radio signals with said first radio node and said second radio node, wherein the timing information is configured by the first radio node based on said measurement information.

The proposed solution has been described in the foregoing by means of various examples. It shall be noted that those examples are non-limiting, and that the features of those examples can be combined in any way or form.

The proposed solution may further take any form as provided in the following claims.

1. A method carried out in a first radio node of a wireless network for configuring a repeater station to repeat radio signals between the wireless network and at least one wireless device, the method comprising:
configuring the repeater station to detect one or more further radio nodes of the wireless network;
receiving an indication of measurement data, obtained in the repeater station based on a reference signal from a second radio node of said one or more further radio nodes; and
transmitting a control signal to control the repeater to repeat radio signals associated with at least one of the first radio node and the second radio node, based on the received indication.

2. The method of claim 1, wherein the control signal identifies timing information for the repeater station to repeat said radio signals.

3. The method of claim 2, wherein the timing information identifies an on-period for the repeater station to repeat radio signals associated with either the first radio node or the second radio node.

4. The method of claim 2, comprising:
obtaining information identifying dual radio capability of the repeater station,
wherein the timing information identifies an on-period for the repeater station to repeat radio signals associated with either or both of the first radio node and the second radio node.

5. The method of claim 2, wherein the timing information further identifies an uplink/downlink scheme for operating the repeater station.

6. The method of claim 1, wherein configuring the repeater station comprises transmitting, to the repeater station, information identifying a reference signal for each of said one or more further radio nodes.

7. The method of claim 6, wherein said information identifies beam-specific reference signals for each of said one or more further radio nodes.

8. The method of claim 6, wherein said information identifies cell-specific reference signals for each of said one or more further radio nodes.

9. The method of claim 1, wherein said repeater station is mobile.

10. A method carried out in a repeater station for enabling the repeater to repeat signals between a wireless network and at least one wireless device, the method comprising:
obtaining, from a first radio node of the wireless network, configuration information for the repeater station to detect one or more further radio nodes of the wireless network;
measuring a signal characteristic of a reference signal, received from a second radio node of said one or more further radio nodes, to generate measurement data;
transmitting an indication of the measurement data to the first radio node; and
receiving a control signal from the first radio node, which controls the repeater station to repeat radio signals associated with at least one of the first radio node and the second radio node, based on the transmitted indication.

11. The method of claim 10, wherein the control signal identifies timing information for the repeater station to repeat said radio signals.

12. The method of claim 11, wherein the timing information identifies an on-period for the repeater station to repeat radio signals associated with either the first radio node or the second radio node.

13. The method of claim 11, comprising:
transmitting information identifying dual radio capability of the repeater station,
wherein the timing information identifies an on-period for the repeater station to repeat radio signals associated with either or both of the first radio node and the second radio node.

14. The method of claim 11, wherein the timing information further identifies an uplink/downlink scheme for operating the repeater station.

15. The method of claim 10, wherein obtaining configuration information comprises receiving information identifying a reference signal for each of said one or more further radio nodes.

16. The method of claim 15, wherein said information identifies beam-specific reference signals for each of said one or more further radio nodes.

17. The method of claim 15, wherein said information identifies cell-specific reference signals for each of said one or more further radio nodes.

18. The method of claim 10, wherein said repeater station is mobile.

19. The method of claim 10, comprising:
repeating radio signals associated with at least one of the first radio node and the second radio node, according to the control signal.
